(19) United States
(12) Patent Application Publication
(10) Pub. No.: US 2016/0137238 A1
(43) Pub. Date: May 19, 2016

(54) SEMI-TRAILER COMBINATION

(71) Applicant: FAYMONVILLE DISTRIBUTION AG, Weiswampach (LU)

(72) Inventor: Alain FAYMONVILLE, Weiswampach (LU)

(73) Assignee: FAYMONVILLE DISTRIBUTION AG, Weiswampach (LU)

(21) Appl. No.: 14/817,342

(22) Filed: Aug. 4, 2015

(30) Foreign Application Priority Data
Nov. 17, 2014 (DE) 20 2014 105 502.9

(51) Int. Cl. B62D 53/06

(52) U.S. Cl. CPC B62D 53/067

(57) ABSTRACT

A semi-trailer combination for multiple modules. At least three modules can be drawn apart out of one another, and can be pushed into one another, at least in part. All the modules may be completely pushed against one another. At least two tubular or box-shaped central supports of the second or of the third module may be pushed into corresponding central supports of the first and second modular, entirely or in part.

### CROSS REFERENCE TO RELATED APPLICATIONS

Applicant claims priority under 35 U.S.C. §119 of German Application No. 20 2014 105 502.9 filed Nov. 17, 2014, the disclosure of which is incorporated by reference.

### BACKGROUND OF THE INVENTION

1. Field of the Invention

The invention relates to a semi-trailer combination.

2. Description of the Related Art

Such vehicle combinations are needed to transport heavy goods, but particularly also long goods. Although they are entirely or partially drawn apart in the loaded state, in order to offer the required loading space, they are supposed to be as short as possible when traveling empty because, among other things, longer or particularly long vehicles or vehicle combinations frequently need an accompanying vehicle that warns the oncoming or following traffic about particular traffic hazards. The inability to shorten the vehicle when traveling empty results in unnecessary accompanying service costs.

### SUMMARY OF THE INVENTION

This consideration is where the invention takes its start and provides a semi-trailer combination in which at least three modules can be drawn apart out of one another, and can be pushed into one another, at least in part. It is particularly advantageous if all the modules can be completely pushed against one another.

For this purpose, it is provided that at least two tubular or box-shaped central supports of the second or of the third module can be pushed into corresponding central supports of the first and second module, entirely or in part.

It is advantageous if the first, front module at first has a central support configured as a tube or box.

In a further embodiment, the second, center module has a tubular or box-shaped central support that can be extended forward, viewed in the direction of travel, which support can be pushed into the central support of the first module, entirely or in part, and thereby can be locked into the latter.

Finally, the third, rear module has a rod or tube that is firmly welded on or a box that is firmly formed on, at the front, viewed in the direction of travel. This rod/tube/box can be pushed into the tubular or box-shaped central support of the first module and of the second module, entirely or in part, and thereby can be locked into the central support.

In such embodiments, all of the modules can be pushed completely against one another, particularly if the second module is pushed directly against the first module, and the third module is pushed directly against the second module. This feature is particularly possible in that the rod or tube welded onto the third module at the front, or the box formed on there, can be pushed through the tube that is correspondingly configured to be hollow or through a box of the second module that is correspondingly configured to be hollow, all the way into the first module.

On the basis of provisions of road traffic law, particularly in foreign countries, it is provided that each module has an internal wheelbase of at least 60″=1.524 mm and three axles, wherein the total train length including towing vehicle amounts to maximally 1,080″=27,432 mm. The wheelbase between the individual modules in the partially extended and locked state amounts to 192″=4,876 mm, in each instance. The modules can be extended maximally up to the length of their tubular or box-shaped longitudinal supports.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a schematic side view of a first module;

FIG. 2 is a schematic side view of a second module;

FIG. 3 is a schematic side view of a third module;

FIG. 4 shows the modules according to FIGS. 1, 2, and 3 in the completely pushed-in state;

FIG. 5 is a representation according to FIG. 4 with the towing vehicle 13 indicated;

FIG. 6 shows the modules according to FIGS. 1, 2, and 3 in the partially extended state;

FIG. 7 shows the modules 2, 8, and 9 according to FIG. 6 with the towing vehicle indicated;

FIG. 8 shows the modules 2, 8, and 9 in the completely extended state; and

FIG. 9 shows the modules 2, 8, and 9 according to FIG. 8 with the towing vehicle indicated.

### DETAILED DESCRIPTION OF PREFERRED EMBODIMENTS

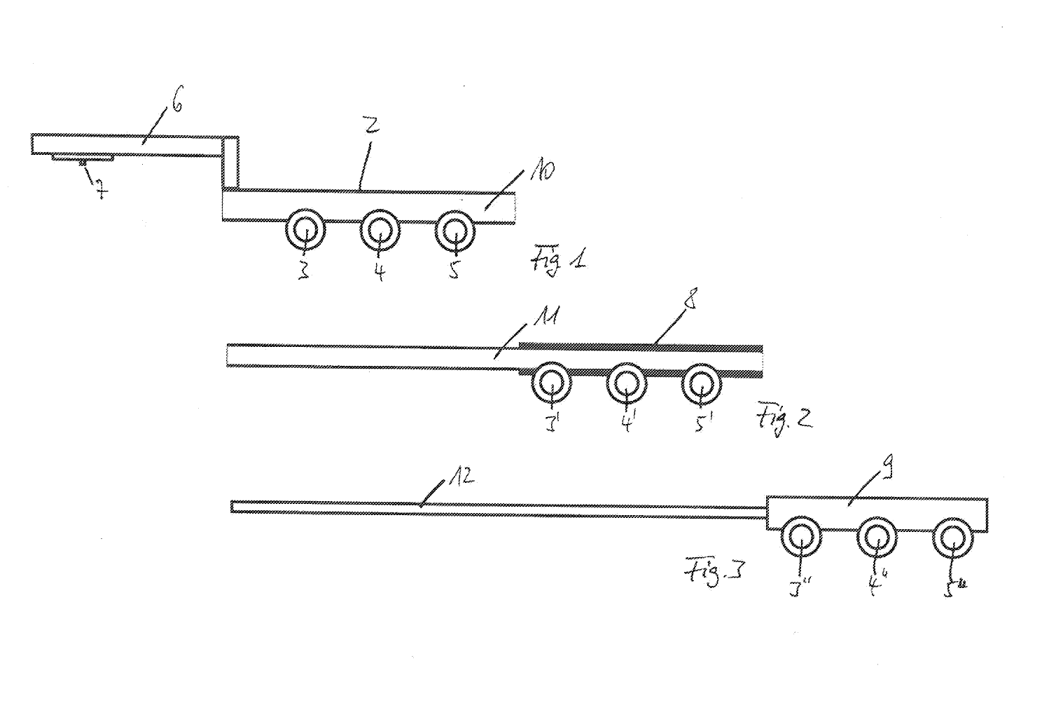

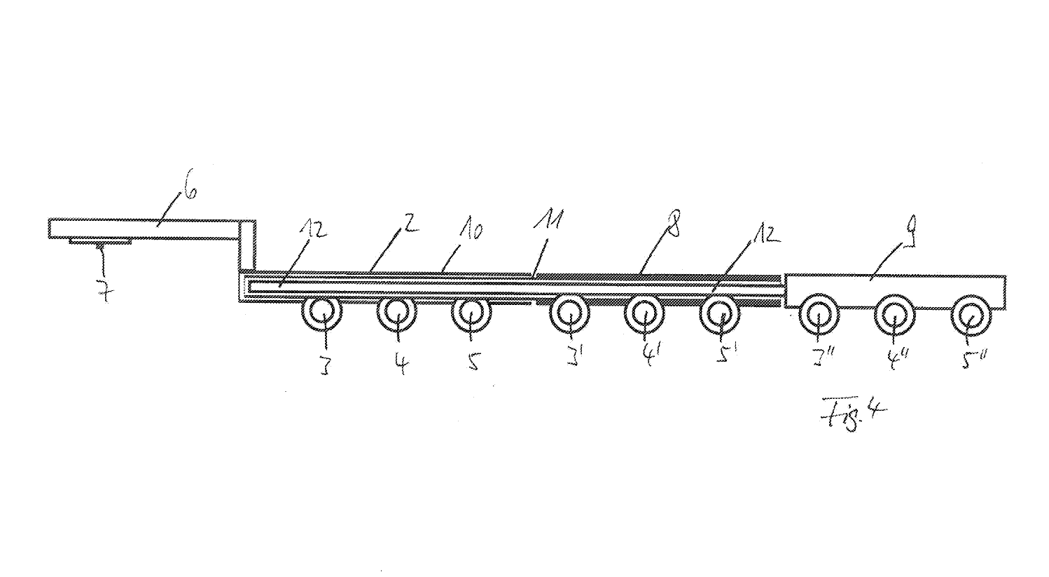

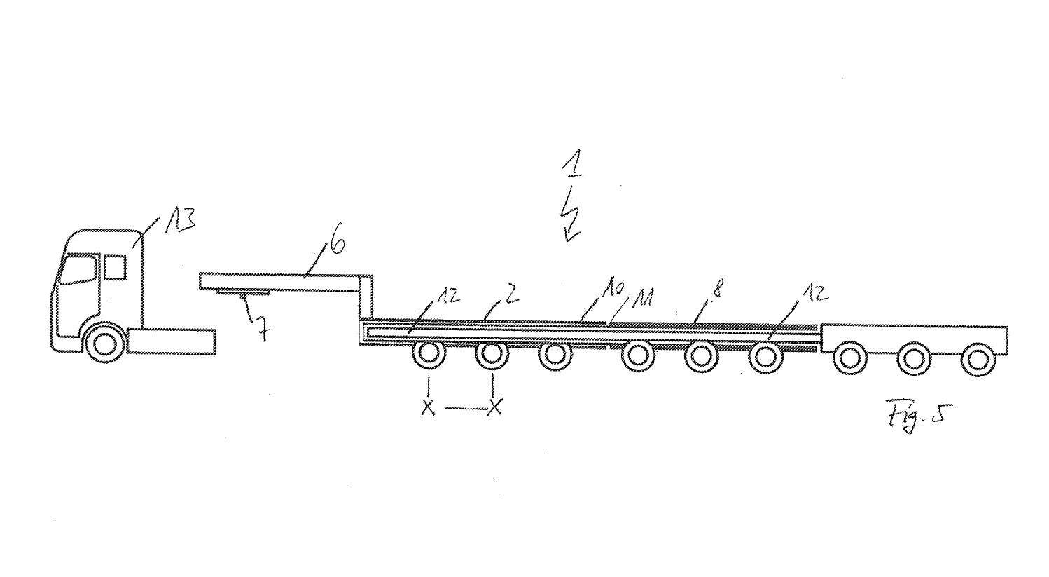

A vehicle combination indicated as a whole as a semi-trailer combination 1 (see, e.g., FIG. 5) has a first module 2 having three axles 3, 4, 5, as well as optionally, a gooseneck 6 having a bearing pin 7. See FIG. 1. A second module 8 shown in FIG. 2, also having three axles 3′, 4′, 5′, and a third module 9 shown in FIG. 3, also having three axles 3″, 4″, 5″ follow. The first, front module 2 (FIG. 1) has a central support 10 configured as a tube or box. The second module 8 (FIG. 2) also has a lengthened central support 11 configured as a tube or box, which is reduced in circumference, in terms of its cross-section, as compared with the central support 10, in such a manner that it can be pushed into this support 10 in the manner of a telescope, i.e. the outside dimensions of the support 11 correspond to the inside dimensions of the support 10.

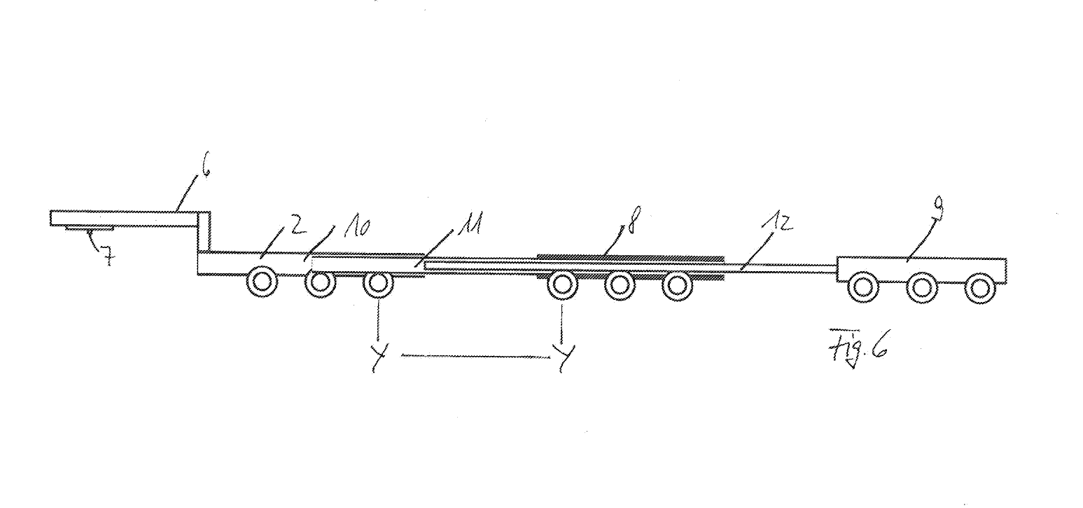

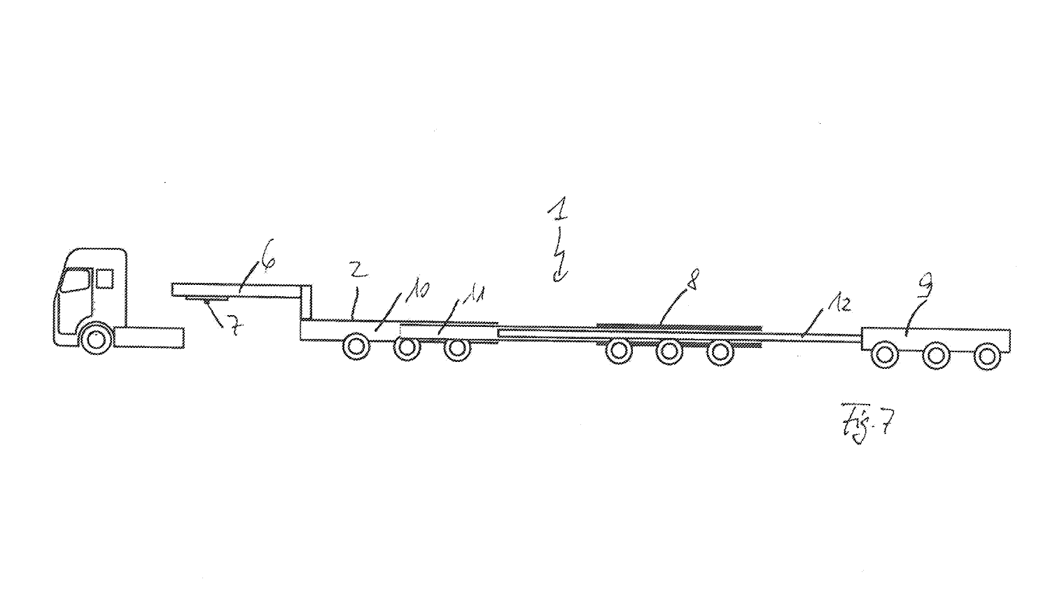

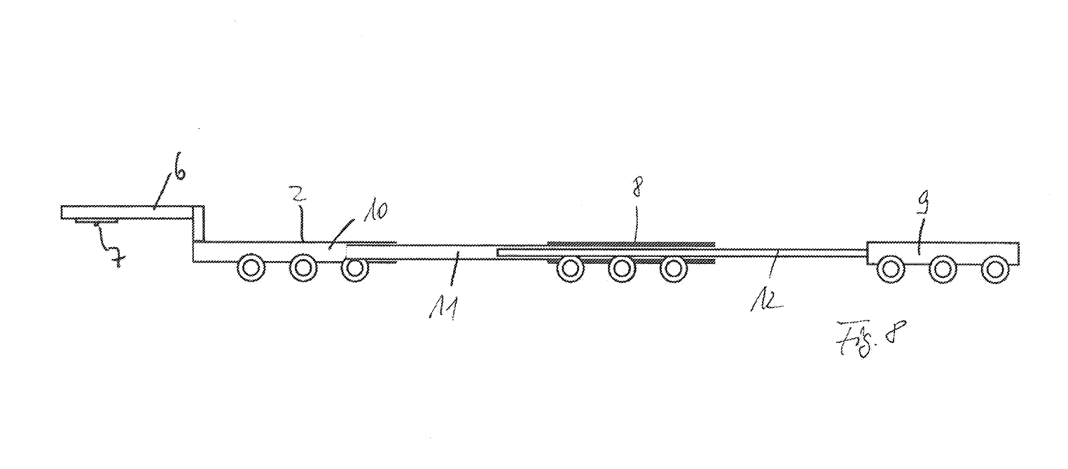

The central support 11 is lengthened toward the front in the form of firmly welded-on tubes or a firmly formed-on box, so that it can be pushed into the central support 10 of the first module and locked into it, as is evident from FIG. 4, for example. There, it is pushed entirely into the first module, while in FIGS. 6 and 7 it is pushed in only partially.

Finally, the third module 9 (FIG. 3) also has a tube firmly welded on at the front or a box 12 firmly formed on. This tube or this box 12 is reduced in circumference as compared with the tube/box or support 11 of the second module 8, in such a manner that it can also be pushed into the support 11 and pulled out of the support 11 in the manner of a telescope. Here, too, FIG. 4 illustrates the entirely pushed-in state, in which the box/tube 12 of the module 9 is pushed entirely into the first module 2, by means of the box or the tube or the support 11 of the second module 8. FIGS. 6 and 7 show the partially pushed-in state.

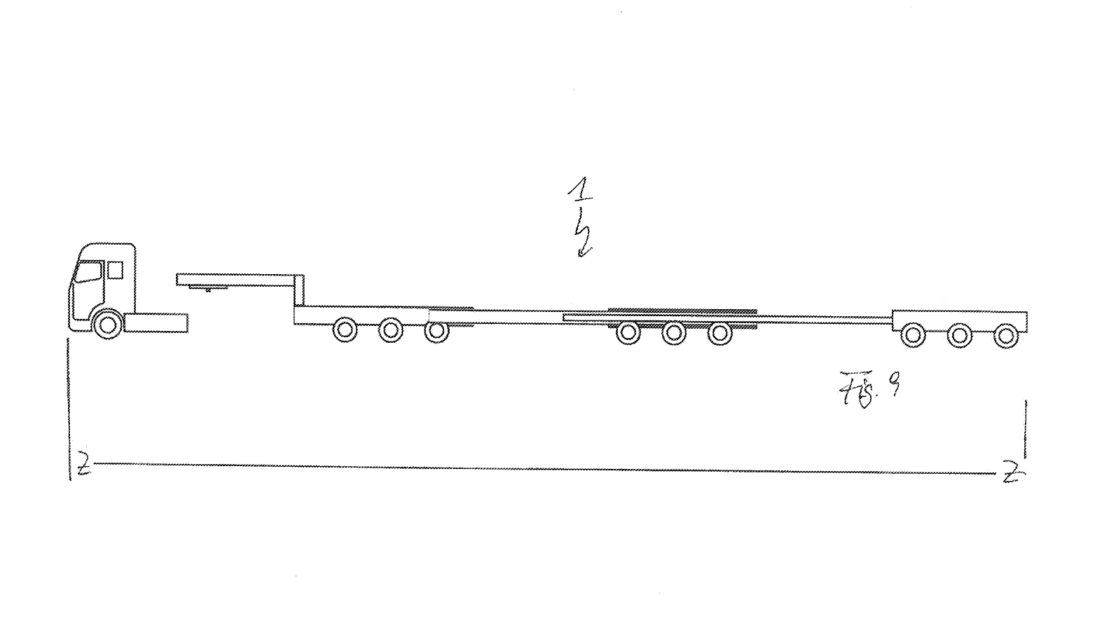

FIGS. 8 and 9, in contrast, show the semi-trailer combination 1 in the completely extended state in the final locked position, i.e. in the transport position for particularly long goods.

The wheelbase X-X between the individual axles 3, 3′, 4, 4′, 5, 5′ amounts to 60″=1,524 mm, in each instance. The wheelbase Y-Y between the individual modules in the partially pulled out and locked state amounts to 192″=4,876 mm, in each instance. The total train length Z-Z including the towing vehicle 13 lies at 1080″=27,432 mm.

Of course, the invention is not restricted to the exemplary embodiments shown. Further embodiments are possible without departing from the basic idea.

Thus, although only a few embodiments of the present invention have been shown and described, it is to be understood that many changes and modifications may be made thereunto without departing from the spirit and scope of the invention.

What is claimed is:

1. A semi-trailer combination comprising at least first, second, and third modules, wherein the first, second, and third modules are drawable apart out of one another and pushable into one another, at least in part.

2. The semi-trailer combination according to claim 1, wherein all of the first, second, and third modules are completely pushable against one another.

3. The semi-trailer combination according to claim 1, wherein the first module has a tubular or box-shaped central first support, the second module has a tubular or box-shaped central second support, and the third module has a tubular or box-shaped central third support; and wherein at least the tubular or box-shaped central second and third supports are pushable into the corresponding central first and second supports, entirely or in part.

4. The semi-trailer combination according to claim 1, wherein the first module is a front module having a central support configured as a tube or box.

5. The semi-trailer combination according to claim 3, wherein the second module is a center module, the tubular or box-shaped central second support is extendable in a forward direction, viewed in a travel direction, and the central second support is pushable into the central first support of the first module, entirely or in part, and thereby is lockable into the central first support.

6. The semi-trailer combination according to claim 5, wherein the third module is a rear module having a rod or tube that is welded on or a box that is formed on, at a front portion of the third module, viewed in the travel direction, wherein the rod, tube, or box is pushable into the tubular or box-shaped central first support of the first module and into the tubular or box-shaped central second support of the second module, entirely or in part, and thereby is lockable into the first and second supports.

7. The semi-trailer combination according to claim 1, further comprising a towing vehicle, wherein the towing vehicle and the first, second, and third modules have a total train length, wherein each module has an internal wheelbase X-X of at least 60″=1,524 mm and first, second, and third axles, and wherein the total train length Z-Z amounts to maximally 1,080″=27,432 mm.

8. The semi-trailer combination according to claim 1, wherein between each module is a respective wheelbase Y-Y amounting in a partially extended and locked state to 192″=4,876 mm, in each instance.

9. The semi-trailer combination according to claim 3, wherein each of the first, second, and third supports has a respective length and the modules are extendable maximally up to the length of the respective length of the support.
